(19) United States
(12) Patent Application Publication
(10) Pub. No.: US 2019/0232425 A1
(43) Pub. Date: Aug. 1, 2019

(54) METHOD FOR LASER WELDING

(71) Applicant: TERMACO LTEE, SAINT-JEAN-SUR-RICHELIEU (CA)

(72) Inventor: Gilles BOUCHER, Lasalle (CA)

(21) Appl. No.: 15/583,332

(22) Filed: May 1, 2017

Related U.S. Application Data
(60) Provisional application No. 62/329,644, filed on Apr. 29, 2016.

(51) Int. Cl. B23K 26/26; B23K 26/03; B23K 26/08; B23K 26/06; G05B 19/402

(52) U.S. Cl. CPC B23K 26/26; B23K 26/032; B23K 26/0884; G05B 2219/37571; G05B 19/402; G05B 2219/45138; B23K 26/0665

(57) ABSTRACT

There is described a method for welding a first panel to a second panel. The method comprises forming an approximate connection, such as a mortise-and-tenon or a tongue-and-groove connection, to preassemble the first panel and the second panel, thereby roughly creating a joint between the first panel and the second panel. With a laser camera, a location and a spatial orientation of the joint is determined using a tracking algorithm. A laser is eventually displaced at a given location which depends upon the location and the spatial orientation of the joint. The joint is then irradiated with the laser, while displacing the laser along the spatial orientation of the joint, to weld the first panel with the second panel.

### CROSS-REFERENCE TO RELATED APPLICATIONS

This application claims priority from U.S. provisional patent application No. 62/329,644 filed on Apr. 29, 2016, the specification of which is hereby incorporated by reference.

### BACKGROUND

### (a) Field

The subject matter disclosed generally relates to welding. More specifically, it relates to laser welding, joint location and adaptive tracking.

### (b) Related Prior Art

Cabinets, racks, trays and other types of enclosures for holding electrical equipment, especially high-power batteries, must withstand harsh conditions that may exist upon failure of the equipment. There exist methods for welding the panels which form such enclosures.

These welding methods usually involve substantial human intervention which can be costly and does not allow achieving optimal welding parameters, thereby negatively altering the quality of welding.

Existing methods usually involve placing pieces to be welded in specifically defined templates, which can be time-consuming and requires dedicated equipment.

Furthermore, the location where the welding laser is applied can lack precision due to part warpage or improper assembly, for example. The quality of welding is thereby affected.

### SUMMARY

According to an aspect of the invention, there is provided a method for welding a first panel to a second panel. The method comprises:
forming an approximate connection to preassemble the first panel and the second panel, thereby creating a joint between the first panel and the second panel;
using a laser camera, determining a location and a spatial orientation of the joint;
displacing a laser at a given location which depends upon the location and the spatial orientation of the joint, the displacing being based on a tracking algorithm; and
irradiating the joint with the laser, while displacing the laser along the spatial orientation of the joint, to weld the first panel with the second panel.

According to an embodiment, determining the location and the spatial orientation of the joint is performed by a computer operably connected to the laser camera.

According to an embodiment, there is further provided, by the computer, identifying point coordinates as belonging to the joint, excluding the point coordinates as belonging to the joint if they are distant more than a threshold from the average of the point coordinates, averaging the point coordinates which are not excluded into a set of coordinates defining the joint.

According to an embodiment, there is further provided determining a direction vector for future positions of the laser based on a least-square optimization.

According to an embodiment, there is further provided logging the future positions of the laser in the computer.

According to an embodiment, displacing the laser comprises displacing a welding head comprising the laser and the laser camera.

According to an embodiment, there is further provided instructing, by the computer, the welding head for displacing the laser at a next position on the future positions logged in the computer.

According to an embodiment, there is further provided repeatedly determining the location and the spatial orientation of the joint after repeatedly displacing the laser for logging new future positions of the laser in the computer.

According to an embodiment, forming an approximate connection comprises forming one of: a mortise-and-tenon connection, and a tongue-and-groove connection.

According to another aspect of the invention, there is provided a system for welding a first panel to a second panel, the system comprising:
a positioner adapted for forming an approximate connection to preassemble the first panel and the second panel, thereby creating a joint between the first panel and the second panel;
a laser camera for determining a location and a spatial orientation of the joint;
a welding laser to generate a laser beam to weld the first panel to the second panel; and
a translation system for changing the relative location of the welding laser and the positioner, for the laser beam to weld along the joint.

According to an embodiment, there is further provided a welding head holding the laser camera and the welding laser.

According to an embodiment, there is further provided a focusing system and a collimator, provided at an output of the welding laser to focus the laser beam over a surface of the joint.

According to an embodiment, there is further provided a computer operably connected to the laser camera and to the translation system.

According to an embodiment, the computer comprises a memory comprising instructions and a processor operably connected to the memory, to the laser camera and to the translation system, the processor executing the instructions to:
receive image data from the laser camera;
identify a location of the joint in the image data; and
instruct the translation system to change the relative location of the welding laser and the positioner.

According to an embodiment, the processor may be executing the instructions to identify a location of the joint in the image data by averaging points identified as belonging to the joint.

According to an embodiment, the processor may be executing the instructions to: store the location that is identified in a log in the memory for eventually positioning the welding laser above the location.

According to an embodiment, the positioner may be adapted for forming the approximate connection comprising one of a mortise-and-tenon connection and a tongue-and-groove connection.

According to another aspect of the invention, there is provided an assembly having at least two panels, thereby defining at least one joint between adjacent ones of the at least two panels, wherein each one of the at least one joint comprises an approximate connection for preassembling the panels together, wherein the at least one joint is laser welded.

According to an embodiment, the approximate connection may be comprising a mortise-and-tenon connection.

According to an embodiment, the approximate connection may be comprising a tongue-and-groove connection.

As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIGS. 1A to 1D are perspective views illustrating embodiments of a cabinet with welded panels, a welding frame, an assembly module and a rack frame, respectively;

FIG. 2 is a front view illustrating a first panel of a cabinet, according to an embodiment;

FIG. 3 is a front view illustrating a second panel of a cabinet comprising a mortise, according to an embodiment;

FIG. 4 is a perspective view illustrating a first panel and a second panel of a cabinet with mortise-and-tenon connections for pre-assembling, according to an embodiment;

FIG. 5A is a side view illustrating a metallic join being welded using a laser beam, according to an embodiment;

FIGS. 5B-5G are perspective views illustrating a metallic join being welded using a laser beam and different welding techniques, according to various embodiments;

FIG. 6 is a side view illustrating a pre-assembled metallic joint welded using a laser beam, according to an embodiment;

FIG. 7 is a diagram illustrating a positioner for a system for welding using a welding laser and a laser camera, according to an embodiment; and

FIG. 8 is a picture illustrating a high-quality weld resulting from the laser welding, according to an embodiment; and

FIG. 9 is a diagram illustrating a computer operably connected the laser camera and to the translation system of the welding laser for controlling the position of the welding laser based on input from the laser camera, according to an embodiment.

It will be noted that throughout the appended drawings, like features are identified by like reference numerals.

### DETAILED DESCRIPTION

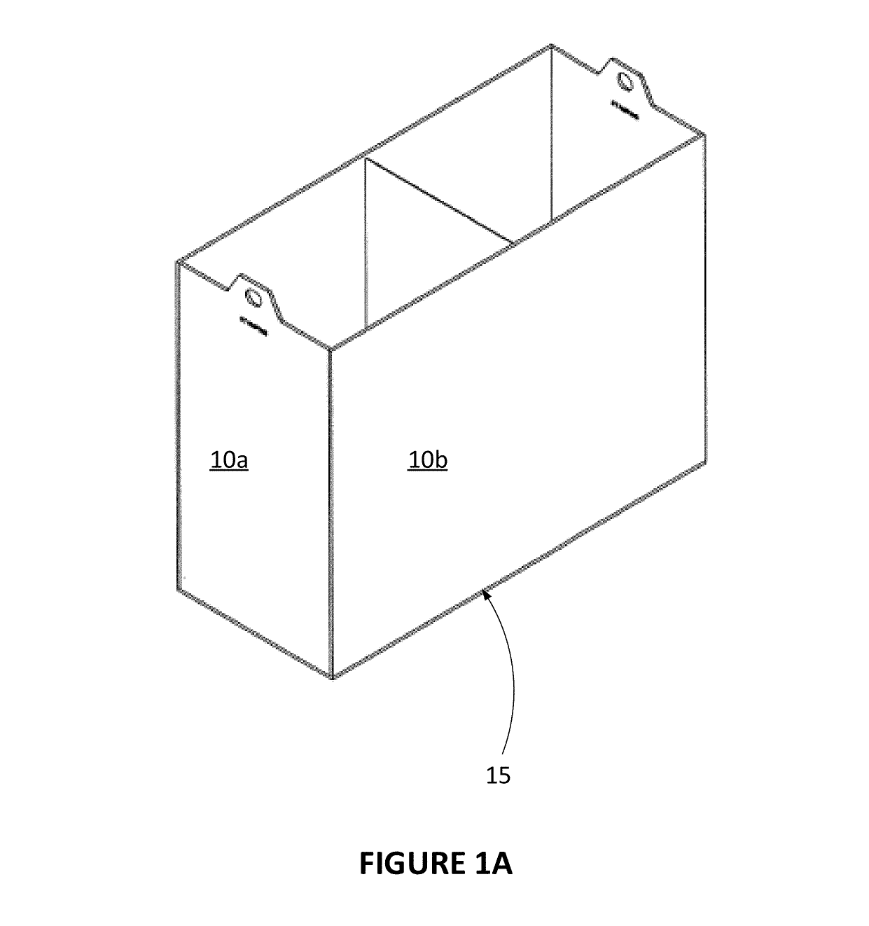

There are described herein embodiments of a system for welding metallic plates, such as the metallic plates forming an assembly 15. The assembly 15 can be a cabinet for holding batteries therein. Such a cabinet is shown in FIG. 1A. The assembly 15 may comprise other types of metallic assemblies such as a tray, a rack, a module and other types of enclosures comprising metallic panels to be welded, as shown in FIGS. 1B-1D.

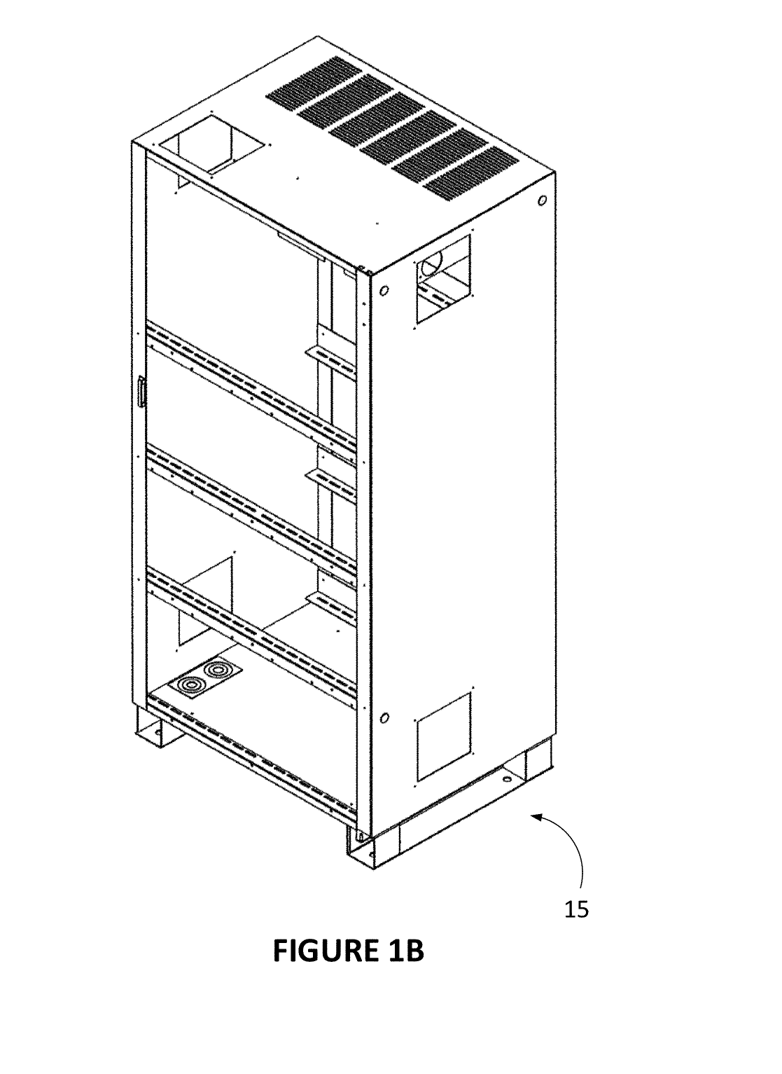

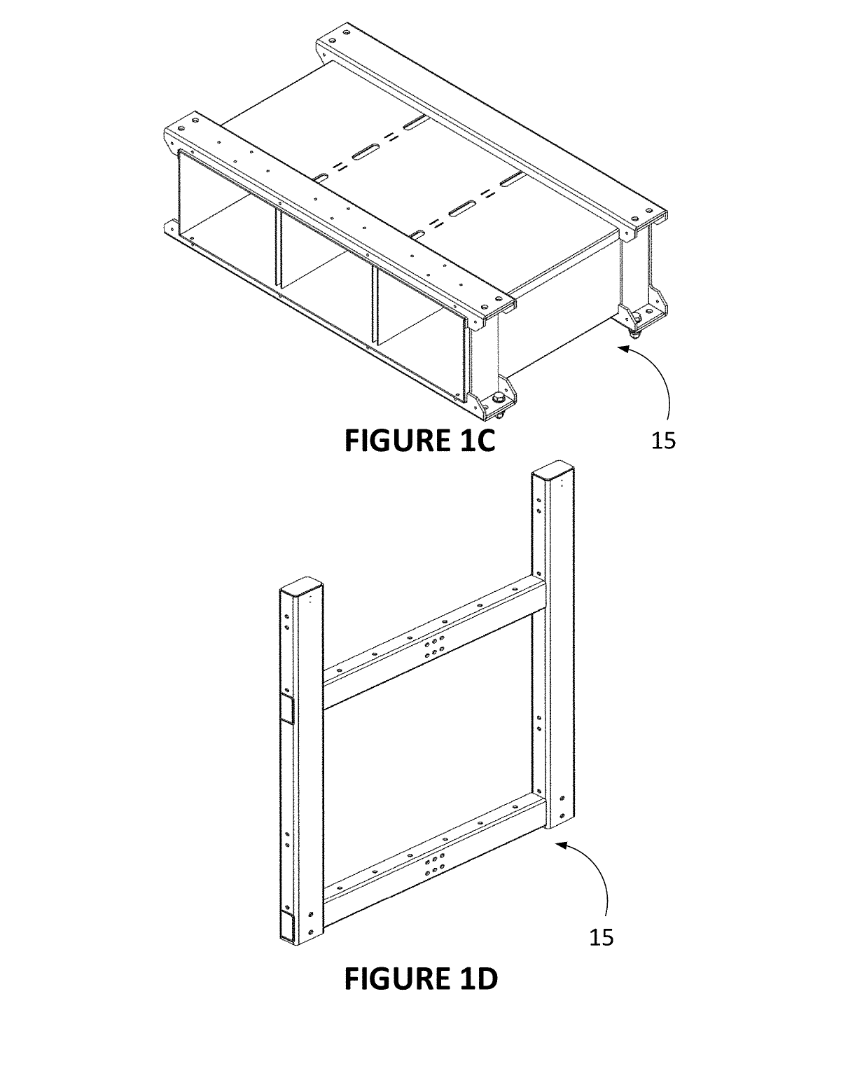

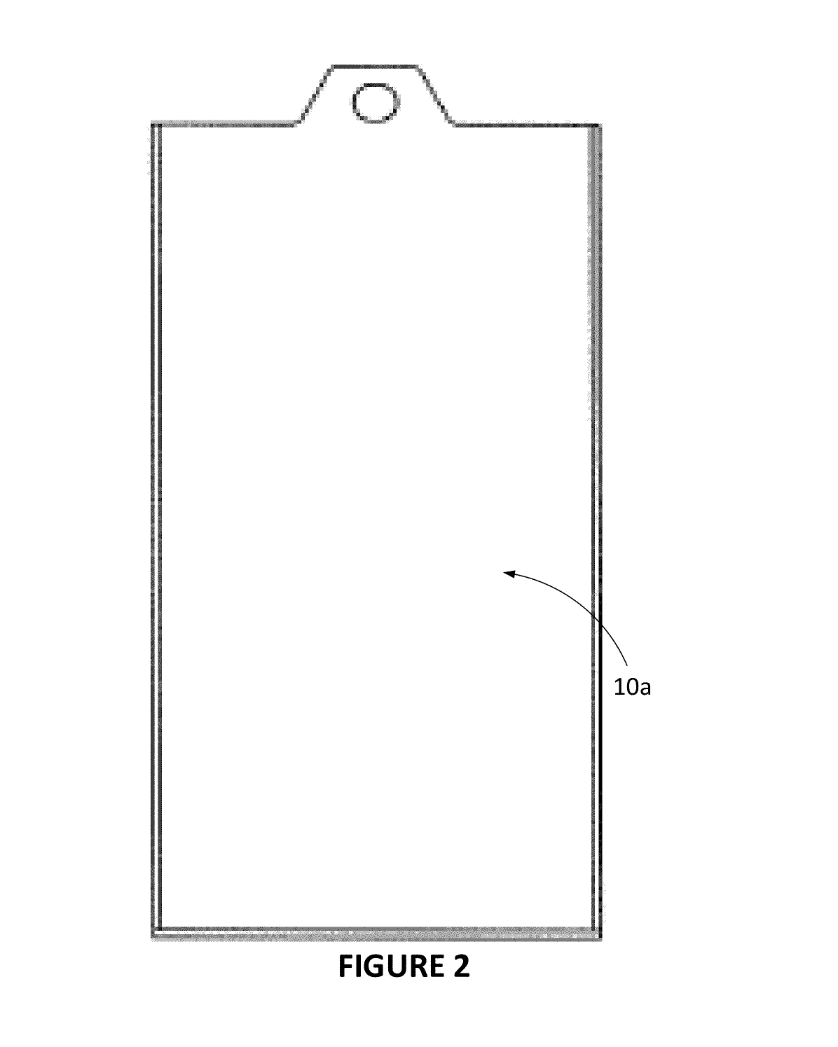

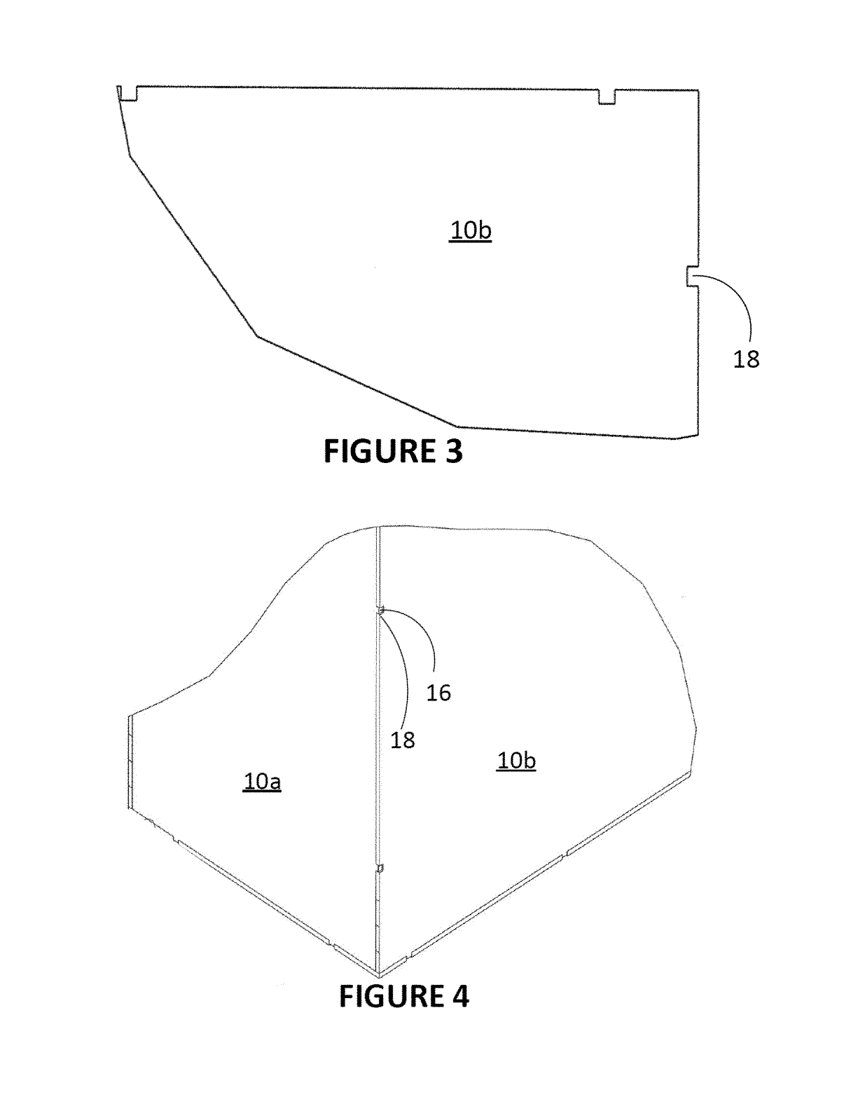

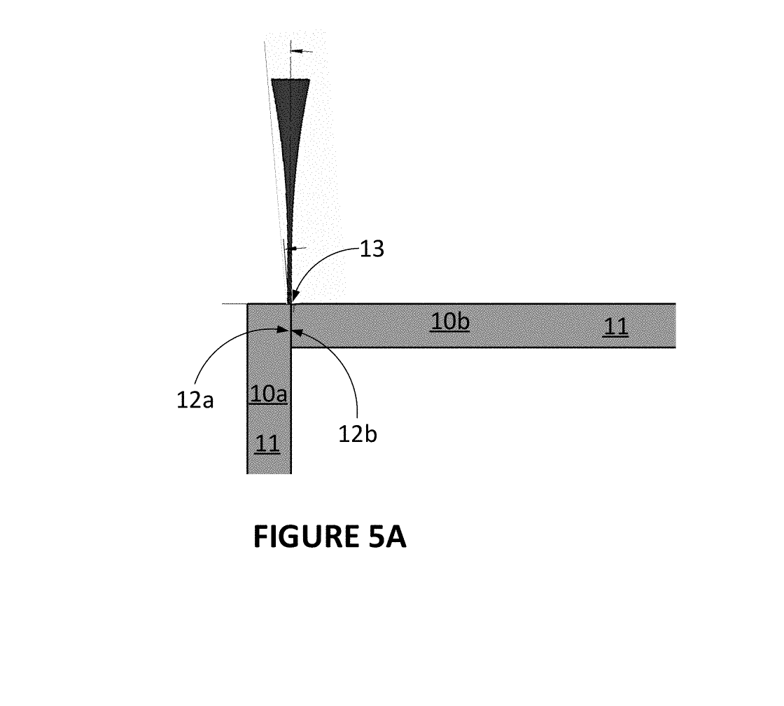

According to an embodiment, the assembly 15 is made of pieces (i.e., plates or panels), as those of FIGS. 2 and 3, to be welded together as shown in exemplary FIG. 4. The type of welding performed by the system described herein can be of various types, such as lap, butt, T-butt, hem or edge joint welding, as shown in FIGS. 5B-5G.

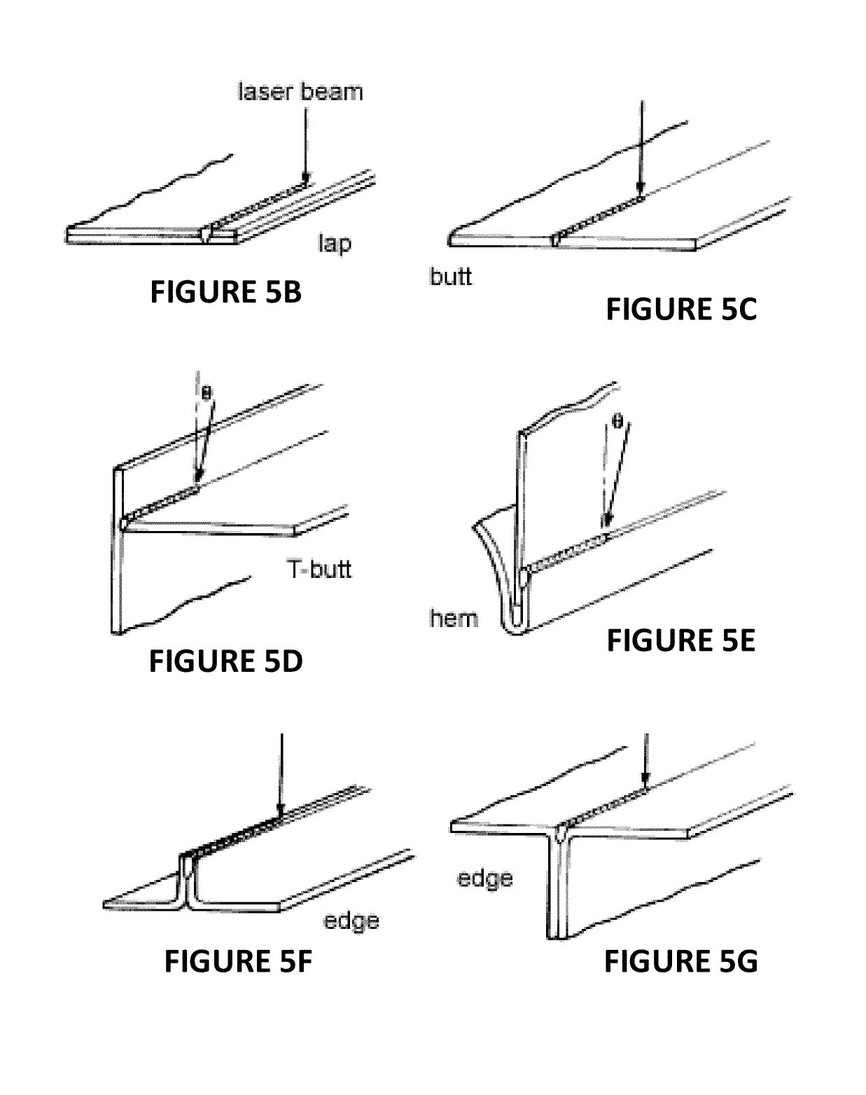

The system comprises a welding laser 100, which is a device held by a welding head, to perform the welding itself. The welding laser 100 should have a power that is sufficient to melt down the metallic material at the joint in order to effectively weld the metallic plates together. The welding laser 100 produces a laser beam that can be focused on designated places on the joint to be welded, as shown in FIGS. 5A-5G, resulting in a welded joint, illustrated in exemplary FIG. 6.

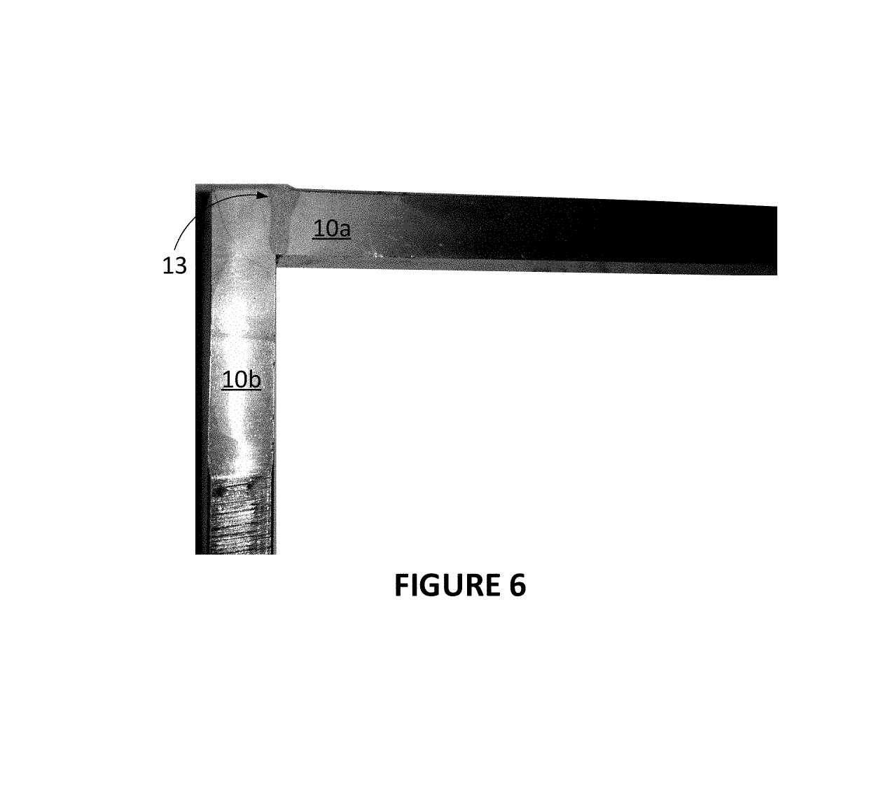

A system for welding the panels together is shown in FIG. 7. According to an embodiment, the welding laser 100 has a power in the order of a few kilowatts. For example, the range of powers may be between 1 and 10 kW. The required power can be greater or lower than these ranges depending on how much the laser beam is focalized on the metallic material to be welded.

According to an embodiment, a focusing device is provided and is operated in conjunction with the welding laser 100. The focusing device is used to focus the laser beam produced by welding laser 100 to substantially increase the power density of the laser beam by reducing the width of the beam. The power density is the power divided by the area (cross-section) of the beam at a given location and is highest at the waist (diameter at the focal plane) of the focused laser beam, where the width of the beam is the smallest. A higher power density implies that a given power contained in the beam is distributed to a smallest volume of metallic material; the more the laser beam is focused, the less the power of the laser needs to be high to melt down the metallic material. According to an embodiment, the focusing device is a lens with a focal length between 100 and 500 mm, or between 200 and 400 mm, or between 250 and 350 mm, or of about 300 mm.

As in other settings, the laser beam can be transported by an optical fiber 130 or other type of optical waveguide from the welding laser 100 to a location closer to the location of the welding and in the right orientation toward the location of the welding. Optical fibers are available in various sizes, the most common one being a diameter of 125 μm often used in signal transmission. However, since the power in the laser beam can be more significant compared to signals used in telecommunications, the optical fiber 130 can be of a diameter greater than 125 μm. For example, a 200 μm-diameter optical fiber can be appropriate to transport the laser beam of the welding laser 100.

According to an embodiment, a collimator (not shown) is provided at the output of the optical fiber 130 to give to the laser beam the right shape of the wavefront to be properly focused by the focusing device (i.e., the laser beam usually diverges when outputted from the optical fiber, but it should not be divergent when entering the focusing device; the collimator corrects this defect). The collimator can have a focal length chosen in the range between 100 and 150 mm, or between 110 and 140 mm, between 115 and 130 mm, or between 120 and 125 mm, or between 125 and 130 mm. When using lenses with parameters within the ranges specified herein, one can expect the diameter of the waist (on the focal plane) to be in the order of 480 to 500 μm, for example. Preferably, all optical elements are provided on the welding head with the welding laser 100.

The quality of welding is better if the focal plane is located a few millimeters above the surface of the metallic materials to be welded, as determined by the focal length and the relative location of the focusing device with respect to the materials to be welded. Therefore, the point with the highest power density is located in the air above the metallic surfaces. This is to avoid too high power densities which would cut the metallic surfaces instead of welding them.

The laser beam can be normally incident to the surface where the welding is performed, as shown in FIG. 5A. However, a laser beam incident on the surface with a given angle (different than 0°) is also possible, i.e., it may be inclined with respect to the normal of the surface. This configuration is shown in FIGS. 5D-5E.

In embodiments, the joint to be welded is the joint between two metallic panels. Prior to the welding, the joint is roughly or approximately preassembled, i.e., the panels 10a, 10b are put in contact and are in some way kept in contact. At this point, the panels are said to be preassembled because they are in contact with each other, thereby forming the join. This preassembling is however approximate in that the joint formed thereby does not have a definite or precise location, and the way it extends in space is not definite or precise. It thus needs to be localized before welding, and the welding laser 100 that performs the welding also needs to be dynamically guided along the top border 13 of the joint during welding, based on a real-time tracking of the joint with a laser camera 200.

According to an embodiment, the joint may be a butt joint, and the panels forming the joint are preassembled by putting them in contact. In this case, the panels 10a, 10b held in place under their own weight, and can be assisted by some corner, wall or protrusion to hold panels perpendicularly, for example. According to another embodiment, the joint may comprise a mortise-and-tenon connection, or a tongue-and-groove connection, for preassembling. As shown in exemplary FIGS. 3 and 4, the first panel 10a can comprise a plurality of tenons 16, and the second panel 10b can comprise a plurality of corresponding mortises 18. Alternative or additional means for preassembling can also be provided.

Preassembling a joint (e.g., using a mortise-and-tenon connection as in FIGS. 3-4) is advantageous in that a worker or an automated device (e.g., a robot) only needs to join both panels 10a, 10b roughly together. Even though they are still not welded, they are pre-assembled, thereby giving the desired shape/configuration to the pair of metallic panels 10a, 10b. Once pre-assembles, the joint needs to be solidified by welding. This step can be done in an automated way, as long as proper guidance is provided (as detailed further below). The rough pre-assembly which is made possible by putting the panels 10a, 10b into contact or by using additional connecting means for preassembling ensures that the preassembled joint (not yet welded) is nonetheless precise enough so that an automated welding can perform the welding reliably.

The first panel 10a comprises a body 11, i.e., the plate itself, having a shape appropriate for its intended purpose (e.g., the wall of an assembly 15). The first panel 10a ends at a surface which will undergo welding; this is the butt surface 12a. The butt surface 12a will be put in contact with, and optionally attached to, a similar surface of the other panel for preassembling and eventually welding.

The second panel 10b also comprises a body 11, usually similar to that of the first panel 10a. The second panel 10b ends at a surface which will undergo preassembling and then welding with the butt surface 12a; this is the butt surface 12b. If the surfaces are connected together, connecting means for preassembling can be provided. If a mortise-and-tenon connection is provided such as in the exemplary embodiment shown in FIGS. 3-4, a mortise 18, i.e., a cavity with a shape complementary to the tenon 16, is provided from the butt surface 12b into the body 11.

Preassembling provides an approximate connection of panels 10a, 10b, which is both fragile and not precise. However, the preassembling can be manually or automatically performed very rapidly; it does not require skill or precision, and, usually, only one movement needs to be performed to preassemble panels 10a, 10b. The panels 10a, 10b should at least be held together solidly enough to be able to perform the welding.

Once the panels 10a, 10b are preassembled they are laid down on a positioner 160, also known as a welding table, which has a main surface, or working surface, (i.e., the table itself) and may include a protrusion extending upwardly from the table, the protrusion forming a corner. This protrusion allows placing two panels together with a perpendicular joint, as shown in the testing workbench of FIG. 7. According to an embodiment, the protrusion forming a corner is sufficient to preassemble the panels 10a, 10b even though they have no complementary connections formed thereon. Indeed, the panels 10a, 10b can be held in place under their own weight in the corner formed by the protrusion; they are thereby preassembled, and joint location for laser welding can be performed on these preassembled panels 10a, 10b. According to an embodiment, the positioner 160 comprises a conveyor, translation belt, translation rail or any other type of translation system 165, such as a 3D translation system, or preferably a 5-axis translation system, to translate the preassembled panels 10a, 10b on the positioner 160, with respect to other pieces of equipment that may be installed around the positioner (e.g., the welding laser 100). Alternatively, and equivalently, the equipment installed around the positioner 160 can be translatable with respect to the positioner using a translation rail, for example. According to an embodiment, all horizontal translations are provided by a translation belt on the positioner 160, while the vertical translation is provided by a translation device that moves the welding laser 100 and/or the focusing device or other optical elements up and down to place the focal plane at the desired height with respect to the preassembled panels 10a, 10b. In FIG. 7, the translation system 165 is shown as a rail on which the welding laser 100 and all the optical elements, namely the laser assembly, are installed. In this embodiment, the positioner 160 does not move; the laser assembly is robotized and moves to the desired location. The laser assembly can be supported by a welding head provided with, or close to, the positioner 160 so that the welding laser 100, the laser camera 200 (described below) and other optical devices can be installed over the table.

Close to the welding laser 100, there is provided a guide which will be used to guide the welding. According to an embodiment, the guide is a laser camera 200. The laser camera 200 is a camera that uses a laser to measure or to evaluate the distance of objects (such as the preassembled panels 10a, 10b). According to an embodiment, the laser camera 200 is provided on the welding head, along with the welding laser 100, preferably a few inches (or a few centimeters) ahead of the welding laser 100.

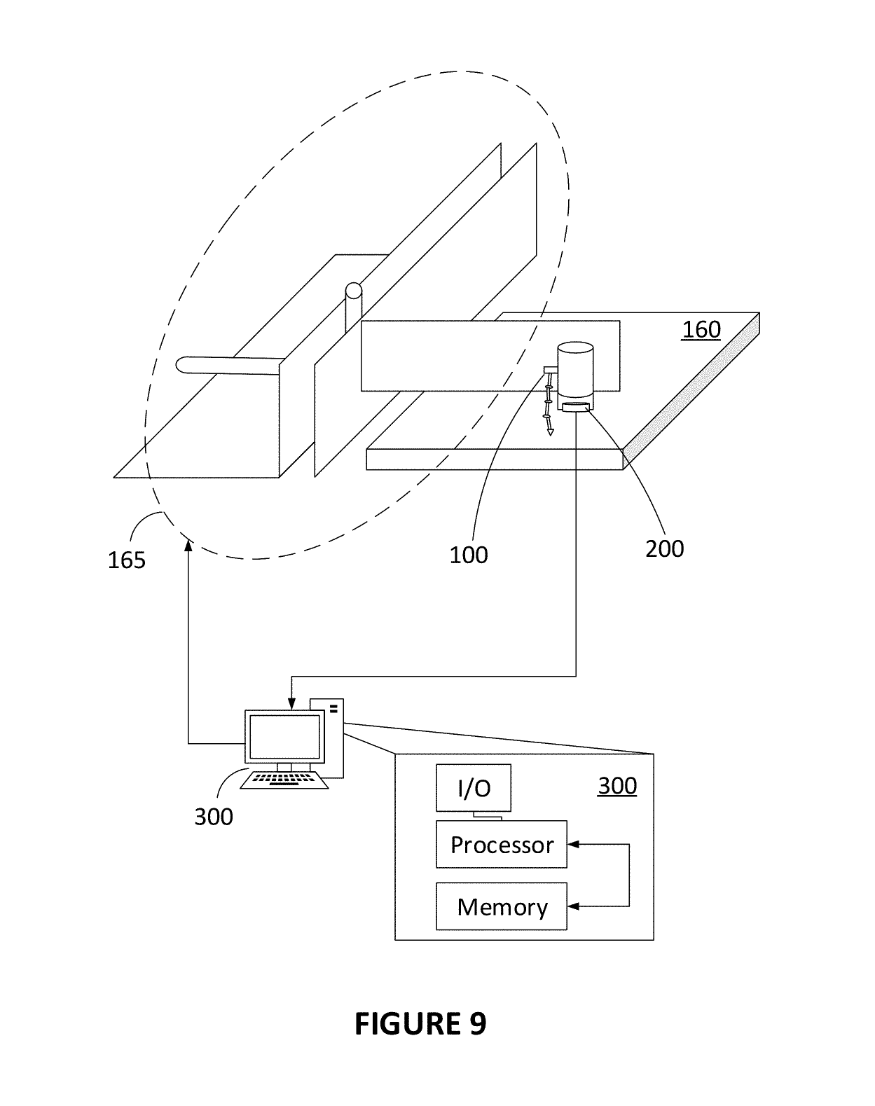

The images captured by the laser camera 200 can be sent to a computing device 300 as shown in FIG. 9, with a program (which may comprise a tracking algorithm described further below) stored on a memory of the computing device 300 and executable on the processor of the computing device 300 to locate the top border 13 of the surfaces 12a, 12b to be welded together. Indeed, once the panels 10a, 10b are preassembled, the surfaces 12a, 12b are brought together and, from above, only the top border 13 of the joined surfaces 12a, 12b can be seen. The laser camera 200, in combination with the appropriate method implemented in the computing device 300 to which it is operably connected, can identify this top border 13, thereby performing joint location using appropriate algorithms.

According to an embodiment, the laser camera 200 can also determine the width of the preassembled panels 10a, 10b, which correspond to the height of the surfaces 12a, 12b along which such surfaces are welded. The determination of this distance may be useful in determining optimal welding parameters.

Once the exact location and spatial configuration of the top border 13 is determined using the laser camera 200, the computing device 300 can send an instruction signal to the translation system 165 to move the preassembled panels 10a, 10b to a given location. This location where the preassembled panels 10a, 10b should be moved depends on the parameters of the laser beam with respect to the surfaces to be welded. Indeed, the preassembled panels 10a, 10b are placed approximately under the welding laser 100 in order to be welded. However, the precise location depends upon the exact parameters that are needed, such as the penetration angle of the laser beam into the surfaces 12a, 12b, and the location of the focal plane of the laser beam with respect to the top border 13. The effect of these parameters is discussed above. For example, the computing device 300, after having determined to exact spatial coordinates of the top border 13 (along the x- and y-axes, and possibly the z-axis too) can determine the exact location and orientation that the top border 13 must have in order to irradiate the top border 13 with the laser beam having a given penetration angle, with a focal plane located 10 mm above the top border 13. Knowing the initial and final positions, the computing device can calculate the displacement that is needed (along the x- and y-axes, and possibly the z-axis too, and the angular displacements, i.e., horizontal rotations) and instruct the translation system 165 to perform the required displacement to reach the desired final configuration of the preassembled panels 10a, 10b with respect to the welding laser 100.

Once the welding begins at a precise location on the preassembled panels 10a, 10b, the preassembled panels 10a, 10b usually needs to be moved during the welding so that the laser beam performs the actual welding on substantially the whole length of the top border 13 and the joint beneath the top border 13. Moving the preassembled panels 10a, 10b while they are being welded implies the same translation system 165 as when moving the preassembled panels 10a, 10b in preparation for the welding.

According to an embodiment, the welding tracking algorithm is implemented in the computing device 300 with a program stored on a memory of the computing device 300 and executable on the processor of the computing device. According to an embodiment, the computer 300 is a programmable-logic controller (PLC) which implements the algorithm. The tracking algorithm uses as an input the data collected by the sensor of the laser camera 200, connected to the PLC via a high-speed communication network. The image data are thus continuously fed to the computer 300 for analysis.

Using some criteria as common in image recognition, points in the image that belong to the joint can be identified. This identification can be based on an intensity or color basis, or on a variation in intensity or color which are characteristic of edges.

However, many points may belong to this definition as the quality of the image is quite noisy. The data received by the computer 300, or PLC, is therefore treated by a numerical filter which is an average algorithm (implemented within the computer 300 as a part of the tracking algorithm) with boundary rejection, i.e., values outside a “boundary” or threshold are rejected. Usually, a given number of times the standard deviation of the set is used as a threshold (e.g., values outside 3σ are rejected and the new set without these values is reconsidered, iteratively until no value is rejected). The average of all values of the set is then kept. These steps form a numerical filter within the algorithm. This is because the exact, precise location of where the welding head should be located is not very clear on the picture, because panel edges have a certain width and defects are present in the materials, hence the use of averages, boundaries rejections, and (as described below) least-square optimization.

At this point, large amounts of samples are used for the averaged anticipated position of the welding head (i.e., the resulting location of the steps of averaging and boundary rejections), producing a 100 ms response time (i.e., the result of the algorithm can be computed within a period of about 100 ms) to allow moving the welding head at a sufficient speed with respect to the location where it should be located as the welding advances.

Once the welding is started, the data sent after the numerical filter is applied to the data logger is treated by a least-square algorithm to produce a 2D vector (i.e., a vector of (x,y) coordinates) based on the last measured distance ahead of the welding head. This series of (x,y) coordinates indicates the future direction that the welding head should take upon displacement, when the welding laser 100 reaches the location where the laser camera 200 is located during image data acquisition (as the laser camera 200 is located a few inches in front of the welding laser 100 on the welding head). The least-square algorithm applies a calculation of the vector (i.e., coordinates) that minimizes the sum of the square in differences with all collected points.

This vector is producing a 2-axis coordinate data log (i.e., a 2×N matrix or series of (x,y) future position, recorded repeatedly and periodically during a period of time) that will be used to position the laser beam directly on (i.e., above) the desired welding point, by having the computer 300 instruct the positioner of the welding head accordingly. This is done in real-time (i.e., a decision of where displacing the welding head next is taken within a period of 100 ms). This determination is taken repeatedly each time the welding head is displaced to a next point, and thus appears continuous, hence the “real-time” movement.

Therefore, as the welding head is displaced to a new position in the log (which is for example stored on the memory) of the future positions that need to be reached for laser welding, the laser camera 200 which is also located in the welding head is displaced too and has new image data to capture and send to the computer 300. As this new data is acquired, at each displacement of the welding head, a new determination of future positions where the welding head will have to be displaced are determined and logged at the end of the log for eventual displacement of the welding head above these positions.

The welding is thereby made adaptive, producing a more accurate result, taking advantage on the tracking algorithm. The panels 10a, 10b only need to be roughly preassembled, i.e., put together with a very loose requirement on the precision of the location of the joint. They are then laid down on the positioner 160 without any requirement. Regardless of the position of the preassembled panels 10a, 10b on the positioner, and regardless of the precision of the location of the joint, the welding can be performed each time with substantially the same quality since the laser camera 200 identifies the exact location and spatial configuration of the panels 10a, 10b and has them move to the location where the welding parameters will be optimal. This system contrasts with existing systems where a template is predefined on the positioner and the panels to be welded must be specifically installed in the template.

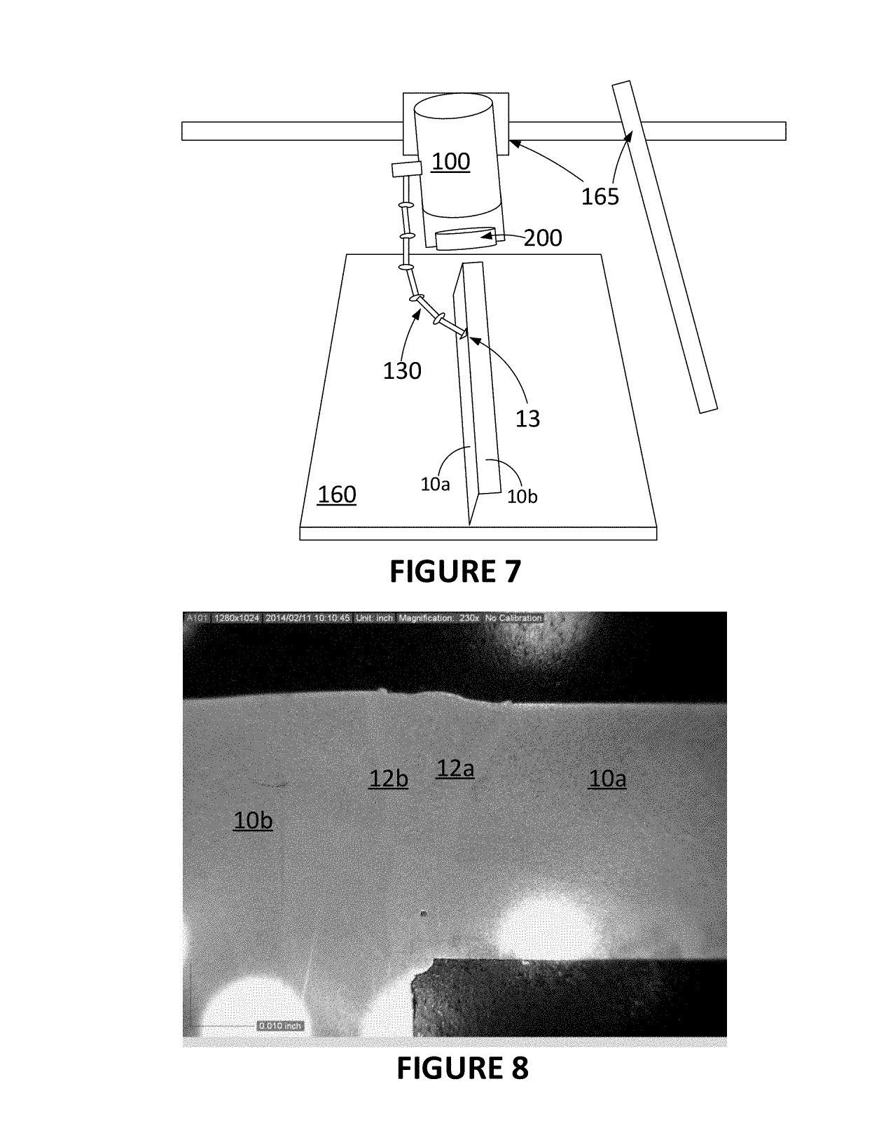

Since the laser camera 200 is capable of high-precision on the determination of the location and spatial configuration of the top border, the translation system 165 should have an approximately equivalent precision and the final result is that the laser beam can penetrate the joined surfaces 12a, 12b with a very high precision on the parameters of the laser welding. The result is a high quality of welding, as shown in FIG. 8 where the complete weld across the depth demonstrates a satisfying penetration of the laser beam within the material to be welded. This quality can be replicated. The reproducibility of the high quality of the welding is advantageous from the standpoint of industrial quality insurance.

The plurality of panels or other metallic pieces which make up the assembly 15 can define a plurality of borders or joints (such as the joint between the bottom panel and each one of the four side panels, and the joint between a side panel and each one of its two neighbors, in the exemplary cabinet of FIG. 1A). According to an embodiment, most of the joints, if not all, are preassembled using an approximate connection (such as a butt joint connection preassembled using a corner, or any other additional connecting means, etc.) and are then laser-welded.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for welding a first panel to a second panel, the method comprising:
forming an approximate connection to preassemble the first panel and the second panel, thereby creating a joint between the first panel and the second panel;
using a laser camera, determining a location and a spatial orientation of the joint;
displacing a laser at a given location which depends upon the location and the spatial orientation of the joint, the displacing being based on a tracking algorithm; and
irradiating the joint with the laser, while displacing the laser along the spatial orientation of the joint, to weld the first panel with the second panel.

2. The method of claim 1, wherein determining the location and the spatial orientation of the joint is performed by a computer operably connected to the laser camera.

3. The method of claim 2, further comprising, by the computer, identifying point coordinates as belonging to the joint, excluding the point coordinates as belonging to the joint if they are distant more than a threshold from the average of the point coordinates, averaging the point coordinates which are not excluded into a set of coordinates defining the joint.

4. The method of claim 3, further comprising determining a direction vector for future positions of the laser based on a least-square optimization.

5. The method of claim 4, further comprising logging the future positions of the laser in the computer.

6. The method of claim 5, wherein displacing the laser comprises displacing a welding head comprising the laser and the laser camera.

7. The method of claim 6, further comprising instructing, by the computer, the welding head for displacing the laser at a next position on the future positions logged in the computer.

8. The method of claim 9, further comprising repeatedly determining the location and the spatial orientation of the joint after repeatedly displacing the laser for logging new future positions of the laser in the computer.

9. The method of claim 7, wherein forming an approximate connection comprises forming one of: a mortise-and-tenon connection, and a tongue-and-groove connection.

10. A system for welding a first panel to a second panel, the system comprising:
a positioner adapted for forming an approximate connection to preassemble the first panel and the second panel, thereby creating a joint between the first panel and the second panel;
a laser camera for determining a location and a spatial orientation of the joint;
a welding laser to generate a laser beam to weld the first panel to the second panel; and
a translation system for changing the relative location of the welding laser and the positioner, for the laser beam to weld along the joint.

11. The method of claim 10, further comprising a welding head holding the laser camera and the welding laser.

12. The method of claim 11, further comprising a focusing system and a collimator, provided at an output of the welding laser to focus the laser beam over a surface of the joint.

13. The method of claim 11, further comprising a computer operably connected to the laser camera and to the translation system.

14. The method of claim 13, wherein the computer comprises a memory comprising instructions and a processor operably connected to the memory, to the laser camera and to the translation system, the processor executing the instructions to:
receive image data from the laser camera;
identify a location of the joint in the image data; and
instruct the translation system to change the relative location of the welding laser and the positioner.

15. The method of claim 14, wherein the processor executing the instructions to:
identify a location of the joint in the image data by averaging points identified as belonging to the joint.

16. The method of claim 15, wherein the processor executing the instructions to:
store the location that is identified in a log in the memory for eventually positioning the welding laser above the location.

17. The method of claim 10, wherein the positioner adapted for forming the approximate connection comprising one of a mortise-and-tenon connection and a tongue-and-groove connection.

18. An assembly having at least two panels, thereby defining at least one joint between adjacent ones of the at least two panels, wherein each one of the at least one joint comprises an approximate connection for preassembling the panels together, wherein the at least one joint is laser welded.

19. The method of claim 18, wherein the approximate connection comprising a mortise-and-tenon connection.

20. The method of claim 18, wherein the approximate connection comprising a tongue-and-groove connection.
